(19) United States
(12) Patent Application Publication
(10) Pub. No.: US 2006/0255006 A1
(43) Pub. Date: Nov. 16, 2006

(54) Universal fit bottle gripping appendage

(76) Inventors: Samuel James Wagenknecht, Rockford, IL (US); Terry Lee Wagenknecht, Rockford, IL (US); Charles Maxwell Wagenknecht, Rockford, IL (US)

Correspondence Address: TERRY LEE WAGENKNECHT, 6693 HEATHER LANE, ROCKFORD, IL, 61114, US

(21) Appl. No.: 11/131,154

(22) Filed: May 16, 2005

(51) Int. Cl. A47J 41/02; A45F 5/00; B65D 23/12

(52) U.S. Cl. 215/396; 215/390; 215/386; 215/12.1; 224/148.6

(57) ABSTRACT

A more universal fit bottle gripping support for retaining a beverage bottle to another object such as a user's pants belt, wherein said support comprises a pliable, planar, and elongate plastic substrate with at least one or more aperture forming through cut slit(s); and wherein said support is appendable to a bottle's sidewall and or its attached label via means of glue, friction, and or tabular projections, and wherein said another object re-directs weight stress loads upon said support's bottle rim gripping aperture in a more lateral direction against a bottle's neck just vertically below its cap stop rim; to permit a more elongate said bottle rim gripping aperture for a more universal size fitting of said aperture.

### CROSS-REFERENCE TO RELATED APPLICATIONS

| | | | |
|---|---|---|---|
| 5,183,169 | February 1993 | Grzych | 215/100 |
| 5,409,151 | April 1995 | Freimark | 224/148.6 |
| 5,695,232 | December 1997 | Tipp | 294/87.2 |
| 5,882,057 | March 1999 | Fahy | 294/159 |
| 5,938,256 | August 1999 | Lovette | 294/87.2 |
| 5,960,973 | October 1999 | Markson | 215/386 |
| 6,019,335 | February 2000 | Schati | 248/312 |
| 6,029,870 | February 2000 | Giacona | 224/148.6 |
| 6,036,066 | March 2000 | Giacona | 224/148.6 |
| 6,056,115 | May 2000 | Olsen | 206/150 |
| 6,056,173 | May 2000 | Gillespie | 224/247 |
| 6,131,779 | August 1997 | Gendala | 224/148.1 |
| 6,131,780 | October 2000 | Becker | 224/148.6 |
| 6,273,283 B1 | August 2001 | Terrana | 215/383 |
| 6,279,794 B1 | August 2001 | Miyazaki | 224/148.7 |
| 6,283,346 | September 2001 | Thomas | 224/14.6 |
| 6,334,531 | January 2002 | Valkovich | 206/163 |
| 6,352,235 B2 | March 2002 | Cizek | 248/692 |
| 6,394,329 B1 | May 2002 | Magee | 224/678 |
| 6,394,517 | May 2002 | Borg | 294/31.2 |
| 6,349,844 | February 2002 | Betras | 220/709 |
| 6,401,993 | June 2002 | Andrino | 224/148.5 |
| 6,443,338 | September 2002 | Giaconna | 224/148.6 |
| 6,533,148 | March 2003 | Dahl | 224/148.6 |
| 6,571,429 | June 2003 | Yeh | 24/16PB |
| 6,626,333 | September 2003 | Levesque | 224/148.6 |
| 6,695,371 | February 2004 | Simkins | 294/33 |
| 6,837,472 | January 2005 | Beutz | 248/312 |
| 6,857,544 | February 2005 | Dahl | 224/148.4 |

### STATEMENT REGARDING FEDERALLY SPONSORED RESEARCH OR DEVELOPMENT

Not applicable.

### REFERENCE TO SEQUENCE LISTING

Not applicable.

### BACKGROUND—FIELD OF INVENTION

This invention relates to bottle holders and bottle carriers which retain bottles of various cap and neck diameter sizes to another object, such as a user's pants belt, and particularly to plastic bottles with a plastic indicia label, and especially those bottle holders and carriers which are made from a one piece pliable, planar, and elongate plastic material substrate.

### BACKGROUND—DESCRIPTION OF PRIOR ART

Previous items used to attach a plastic bottle of water or soda to another object would comprise many various means of attachment. A few of those included clips, snaps, strings, stretchable plastics or rubbers, hard plastics to grip a bottles cap stop rim, etc. Almost all of said means were expensive to produce, expensive to purchase, and yet bulky and clumsy to store on a user's body when not being used.

None were found which would serve as a throw-away or disposable bottle support or carrier, as all were overly complicated in design, and thus too expensive.

The number of patents which have already been applied for and issued reflect this foreseen need for a user to carry a bottle with their hands free, yet none were found which filled a need for a universal size fitting, while being cost effectively packageable with each bottle produced. Of all prior art searched, most fell into two categories; one of which retained a held bottle within a bag or pouch, and those which gripped a bottle's neck, cap, and or cap stop rim. None were found which sharingly distributed a held bottle's liquid weight stress load between a bottle's cap stop rim neck area, and a bottle's sidewall and or its indicia label, and the object being held to. None were found which made use of an elongate through cut slit formed aperture for a more universal size bottle neck fitting. None were found which used friction as one means of retaining a bottle gripping device to a bottle's sidewall. None were found which used tabular projections as one means to retain a bottle gripping device to said sidewall's attached indicia label. None were found with sanitary proof knock-out apertures. None were found which were made from an indicia label itself. None were found which used their own perimeter shape to foldingly provide their own containment pouch. None were found which could be manufactured from a wide variety of pliable plastic materials, and a wide range of thicknesses.

### BACKGROUND OF THE INVENTION—SUMMARY

A more universal fitting bottle gripping appendage for retaining a bottle to another object such as a user's pants belt, wherein said appendage comprises a pliable, planar, and elongate plastic substrate with at least one or more aperture forming through cut slit(s), and a means for attachment to a bottle's sidewall; wherein a held liquid weight stress load is cooperatively shared between said comprisements and said another object to permit a more universal size fitting bottle gripping aperture.

### BACKGROUND OF THE INVENTION—OBJECTS AND ADVANTAGES

In today's market, small bottles of water are carried everywhere by consumers. When a user needs to have free hands for carrying other items, a bottle of water usually gets jammed into a purse, or stuffed into a pocket, or left behind. This particular universal fit bottle gripping appendage is always close at hand, as it is easily packagable to any bottle with most any standard size neck diameter. One common size which fits several sizes of bottle necks is only one of its merits.

This universal fit bottle gripping appendage may also become part of a company's promotional advertising campaign, as indicia space is provided in the center portion of its main body.

This bottle gripping appendage may also be made from a wide variety of pliable plastics, and ranging from wrap around plastic indicia labels now in use by the bottling industry, to standard milk jug material, to low density polypropylene (LDPE) polyethylene, polystyrene, polyurethane, plastic mylar type films, plasticized cloth type fabrics, and also from a blow molded bottle's sidewall. The type of material chosen by a manufacturer will affect an appendage's bottle neck gripping aperture's size. Said aperture is formed from at least one or more through cut slit(s); wherein a total of said slit(s) form an elongate aperture that elongately parallels said appendage's elongate shape. A single slit aperture is best used for heavier or rip-stop materials such as said (LDPE), or said milk jug material. Said total of said slit(s) is best to arrange in an elongate curvedly shape when a mylar type plastic film substrate is chosen by a manufacturer. Said total of said slit(s) may also form other elongate aperture shapes with chamferred or curved perimeter edge corners to prevent any of one of said total of said slit(s) from tearing to an exterior edge of said appendage.

Once this bottle gripping appendage is temporarily or permanently affixed to a bottle's sidewall, it becomes an appended part of said bottle, or an appendage. A liquid weight stress load is distributed and shared with a locational point of attachment, its means of attachment, a bottle's underside edge of its cap stop rim, a sidewall surface of said bottle's neck located just vertically below said rim, and an object to which said bottle is being held to. Stress forces placed on a bottle gripping aperture are directed from a normally vertically upwards direction to a more lateral direction by said object being held to, and so reduces a need for a more exact fitting bottle neck gripping aperture. Without said locational point of attachment, which is substantially located on a bottle's exterior sidewall and at, on, beneath, or near said indicia label, most weight stress loads would be placed upon said aperture and the immediate area surrounding said aperture, and so would normally require a more exact size and fitting of said aperture.

A means of attachment of said appendage to said bottle's sidewall and or its attached indicia label may be accomplished via adhesive, friction, and or tabular projections. One particular means for said attachment is to position one elongate end of a bottle gripping appendage which is located oppositely from said appendage's gripping aperture's location between a bottle's tightly wrapped plastic indicia label and a bottle's exterior sidewall surface, wherein said appendage is held by friction.

Well over half of the main brands of small bottled water manufacturers use tightly bound plastic labels. Said labels remain tightly wrapped around a bottle, and even after an unsealing and opening of a bottle's cap. As a bottle is emptied, said wrapped label may slightly loosen as a bottle is gripped by a user; yet the liquid weight stress load is lessened also. Said friction between said wrapped label and said bottle is more than sufficient for a retention of said appendage to remain intact as it supports a remaining and smaller liquid weight stress load. Said means of friction works best when using a low density polyethylene material of approximately 0.02 to 0.080 inches thick, and yet is not required, but is preferred.

A consumer who doesn't plan on using a bottle gripping appendage which is frictionally held by a bottle's indicia label, may slightly push a bottle's sidewall inwardly while wiggling said appendage back and forth a few times for its removal and discardment. Meanwhile, a manufacturer's intended indicia message which is printed on said bottle gripping appendage, has been delivered to the consumer as they remove and discard the option of its use.

Accordingly, besides any objects and advantages previously described; further objects and advantages of this present invention are;

(i) A cost effective means for extra indicia space on a plastic bottle, while offering an optional and functional use as a bottle support carrier for a consumer.

(ii) A manufacturer may choose to permanently or temporarily glue an appendage to an exterior surface of a plastic or paper wrapped indicia label.

(iii) A manufacturer may choose to package a bottle gripping appendage behind their own tightly wrapped indicia label, and using said label's own friction as a means for attachment of said support.

(iv) A manufacturer may also choose to allow a consumer to thread their own bottle gripping appendage behind said tightly wrapped indicia label.

(v) An appendage may also be made from a thin plastic mylar type film, wherein it may be folded to create its own pouch, and wherein said pouch may be adhered to a bottle's wrapped label after it's normal application process.

(vi) On some types of plastic substrates, an appendage's through cut slit(s) formed aperture may be in a form of a knock-out, wherein a plurality of said slits are made intermittently in said aperture's perimeter, and wherein a user punches out said aperture for their assurance of first time use and sanitation.

(vii) A bottle gripping appendage which may be appended to both small and large mouth size bottles and to bottles of different vertical heights.

### BRIEF DESCRIPTION OF THE DRAWINGS

In the drawings, closely related figures may have the same number, but different alphabetic suffixes.

FIG. 1,a is a front view of a preferred embodiment.

FIG. 1,b is a perspective view of a preferred embodiment.

FIG. 2 is a side and angular view showing directions of load stresses.

FIG. 3,a is a side view showing direction of load stresses upon an aperture.

FIG. 3,b is a side view showing direction of load stresses upon an aperture.

FIG. 4 is a front view of alternative embodiment with a knock-out aperture.

FIG. 5 is a front view of an alternative baseball bat shaped embodiment.

FIG. 6 is a frontal side view of an alternative baseball bat shaped embodiment.

FIG. 7,a,b are frontal side views as in FIG. 6, before and after knock-outs.

FIG. 8 is a side view of an alternative embodiment positioned for shipping.

FIG. 9,a is an overhead view of the preferred embodiment applied to a small mouth bottle.

FIG. 9,b is an overhead view of the preferred embodiment applied to a large mouth bottle.

FIG. 10,a is an overhead view of an alternative embodiment applied to a small mouth bottle.

FIG. 10,b is an overhead view of an alternative embodiment applied to a large mouth bottle.

FIG. 11 is a front view of an alternative embodiment with water drop shapes.

FIG. 12 is a front view of an alternative embodiment of a mylar type plastic film.

FIG. 13,a,b,c,d are side views of alternative embodiments emerging from its self containing pouch form.

FIG. 14 is a front view of a full size scale of an alternative embodiment.

### BRIEF DESCRIPTION OF THE DRAWINGS—REFERENCE NUMERALS IN DRAWINGS

32—main body of substrate reserved for indicia printing
34—gripping aperture formed by at least one through cut slit
36—gripping aperture formed by a plurality of abutting through cut slit(s)
38—serrated gripping aperture formed by an intermittent plurality of said slit(s)
40—general area of appendage's attachment location to sidewall and or label
42—general area of appendage which is retained to another object
44—double end arrows representing directions of stress
52—another object; in example, a user's pants belt
54—a bottle's cap
56—an underside edge of a bottle's cap stop rim
58—a vertical sidewall of bottle's neck located just underneath the cap stop rim
60—a bottle's sidewall
62—a bottle's affixed indicia label
64—a glued area
66—tab projection(s)
68—fold line areas of light weight mylar type plastic film appendage's self containment pouch

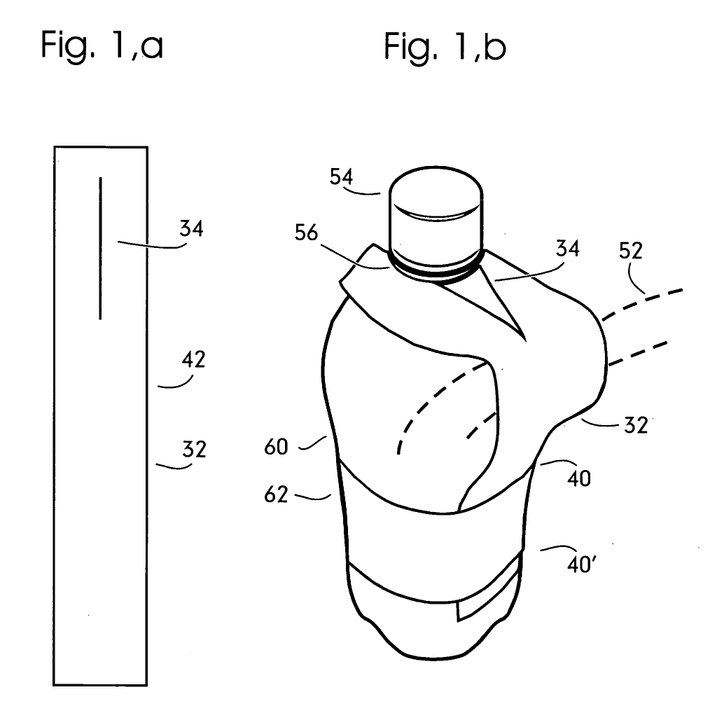

### DETAILED DESCRIPTION OF THE DRAWINGS—FIG. 1,a,b—PREFERRED EMBODIMENT;

In the drawings, closely related figures may have the same number, but different alphabetic suffixes.

A preferred embodiment of a universal fit bottle gripping appendage is shown in FIG. 1,a,b, comprising;
a thin, pliable, and planar elongate plastic substrate body; and in this preferred embodiment, a plastic made of LDPE or low density polyethylene;
at least one aperture forming through cut slit located near one elongate end of said substrate;
and an area for means of attachment located oppositely from said aperture's location.

FIG. 1,a shows a front view of a preferred embodiment before its application to a bottle.

FIG. 1,b shows a perspective view of said preferred embodiment after its application behind a bottle's indicia label, and after said appendage's aperture is positioned vertically below and past said bottle's cap stop rim, and as said bottle and it's appendage and liquid weight stress load are retained to another object, which in this preferred embodiment, is a user's pants belt, and with said belt shown partially, and being represented with dashed lines.

### DETAILED DESCRIPTION OF THE DRAWINGS—OPERATION

In the forming of a preferred embodiment of a universal fit bottle gripping appendage, a manufacturing user may use readily available materials such as a sidewall of a standard one gallon plastic milk jug, or a low density polyethylene flat sheet (LDPE).

An elongate rectangle is cut out with its length being approximately near to a standing bottle's vertical height, and with its width being less than said standing bottle's horizontal width, and with said width being greater than a diameter of a small mouth bottle's neck in said neck's area located just vertically beneath said bottle's cap stop rim. An elongate aperture 36 is formed near one end by at least one or more through cut slit(s). Said aperture's elongate direction parallels an elongate direction of said elongate rectangle. Said aperture's elongate length must be longer than 0.924 inches for its ability to spread open wide enough to surround a standard size small mouth bottle's cap and cap stop rim, and until said aperture is positioned just vertically beneath said rim of said small mouth size bottle.

After said positioning is accomplished, an end of said rectangle which is located opposite from said aperture's location is positioned between said bottle's sidewall and its attached plastic indicia label, and in an area behind said label which is not glued. Said rectangle is now appended to said bottle's sidewall, and is held there by a means; and in this embodiment, by a means of friction. Said bottle's new appendage is now shifted further vertically downward until it extends vertically below said label's lower edge.

Said appendage is now removed from said small mouth bottle and then appended to a large mouth bottle, wherein it is also shifted vertically downward until its elongate end reaches a vertically lower edge of its attached indicia label. Said appendage's elongate length may now be shortened if a manufacturing user chooses to, and according to a degree of universal fitting for different height bottles desired.

Said aperture's planar surface is then positioned vertically above said widemouth bottle's cap. Additional said through cut slit(s) are abutingly added to said aperture's most interiorly located elongate end, and until said manufacturer user determines that said aperture's new elongate length will encompass said widemouth bottle's cap, and its cap stop rim. Said aperture is applied fully, and until it is positioned just vertically beneath said rim for assurance of its fitting.

Said aperture is now removed from said bottle and threaded through an opening of another object such as a user's pants belt, and re-applied to said bottle's cap and again positioned just beneath said rim.

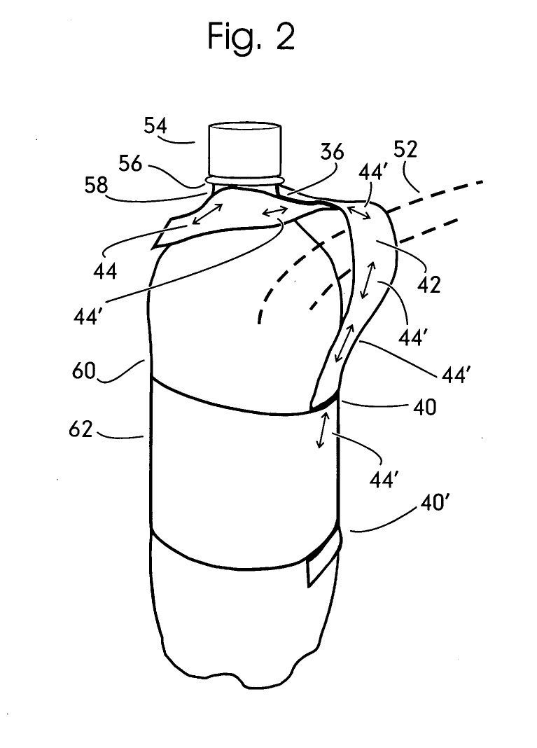

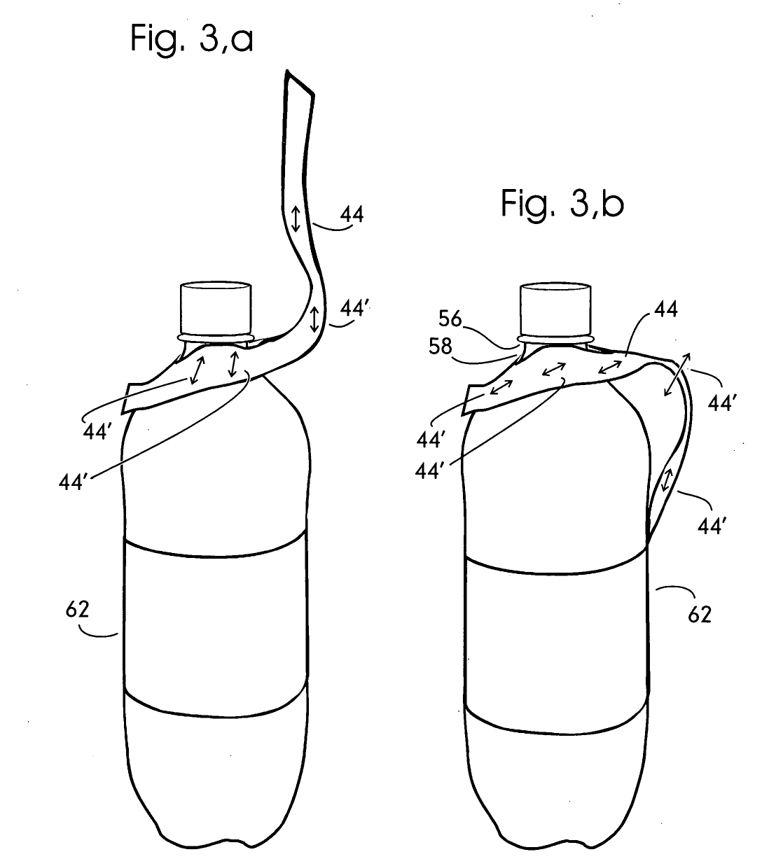

See FIG. 2, as said bottle is held to said another object FIG. 2,52, and under a liquid weight stress load, said object will direct stresses of said load in an area surrounding said aperture in a more lateral direction. Vertically upward stresses between said area surrounding said aperture and said rim's underside edge are reduced, and directed in said more lateral direction against said bottle's neck located just beneath said rim. See FIG. 3,a and FIG. 3,b for comparative said more lateral direction of stresses which permits a larger aperture than if said bottle were gripped by said rim only.

Said appendment to said bottle's sidewall 60 and or its attached indicia label 62 also cooperates with said object to more laterally direct stresses of said load within said appendage in an area surrounding said aperture. Said cooperation retains a full said load even more securely than when retaining a minimal said load, and wherein said load further aids said cooperation.

When a manufacturing user is satisfied with said aperture's elongate length, and said appendage's bottle retaining function, said appendage may be removed from said large mouth size bottle and re-appended between a small mouth size bottle's sidewall and its attached indicia label.

Said aperture containing end is again threaded through an opening of said another object. Said aperture is then again applied surroundingly over said bottle's cap, and again positioned just vertically beneath said cap stop rim.

Final testing is done at this point, as said small mouth bottle size may belong to a 16 ounce, 20 ounce, or 1 liter bottle or more. If desired retention is not achieved between said bottle's neck and said aperture, said appendage can be formed again with a shorter length of said elongate aperture. Said appendage's material strength and thickness affect any tweaking of said aperture's final length.

Once a proper length of said multiple and abutting slit formed aperture FIG. 2, 36 is determined, said manufacturing user may use just one slit for a formation of a single slit formed aperture FIG. 1a, 34.

A manufacturer may also choose to use other means than friction for attachment to a bottle's sidewall and or its attached indicia label. An adhesive may be used within this present embodiment. It may be in a form of glue or double back tape, and may cooperate with a bottle's sidewall directly, or in combination between said sidewall and its attached indicia label, or directly with said label's exterior surface.

Further means include at least one or more tab projections within an alternative embodiment, and are to be addressed within those descriptions.

Comprisements of said elongate aperture, said bottle's sidewall and or its attached indicia label, said another object, said load, said bottle cap stop rim's underside edge, and a vertical exterior sidewall of said bottle's neck located just beneath said cap stop rim, and said means of attachment will all sharingly cooperate to bear said load, as said stress forces surrounding said aperture are directed in a more lateral direction against said vertical exterior sidewall of said bottle's neck to permit a more elongate elongate aperture for a more universal size fitting aperture.

In using a universal fit bottle gripping appendage, a user may also carry it in their hand as they grip an area FIG. 2, 42 between said aperture and a location of said appendage's appendment to a bottle. Said hand becomes said another object instead of a user's pants belt, etc. A same said more lateral direction of stress forces are achieved as said hand grips said area 42. A user may also thread said aperture end through said pants belt, or a pants belt loop. Bicycle handlebars, exercise bikes, baby carriages, and motorcycles are a few examples of equipment which provide easy objects to retain a held bottle and its appendage to.

A manufacturer may choose to apply advertising indicia in an area reserved for indicia space FIG. 1, 32.

When a bottle is emptied and ready to discard, a user may squeeze its sidewall to relieve frictional pressure between said sidewall, its attached indicia label, and said appendage for an easy removal. Said appendage may be saved for future use, or discarded.

### DETAILED DESCRIPTION OF THE DRAWINGS—FIG. 1,a,b THRU FIG. 3,a,b

In the drawings, closely related figures may have the same number, but different alphabetic suffixes.

Further details concerning all drawings include;

FIG. 1,a is a front view of a preferred embodiment; showing a main body of an appendage which is reserved for indicia 32, a single slit formed gripping aperture and a general area of an appendage which is retained to another object 42.

FIG. 1,b is a perspective view of a preferred embodiment with said single slit formed gripping aperture 34 applied to a bottle's neck and positioned just beneath said bottle's cap stop rim 56, and its elongate and opposite end's attachment location 40 being between a bottle's sidewall 60, and its attached indicia label 62, and while being retained to another object 52; and while subjected to a liquid load.

FIG. 2 is a slightly angled side view showing directions of weight load stresses, and with said stress directions represented by double end arrows 44, upon a slit formed aperture 34 and its surrounding area, and other areas within said appendage, and after said attachment of said appendage between a bottle's sidewall 60, and its attached indicia label 62, and while under a liquid weight stress load and when retained to another object 52, such as a user's pants belt which is shown partially and being represented by dashed lines.

FIG. 3,a is a side view showing direction of load stresses, and with said stress directions represented by double end arrows 44, upon an aperture 34 and its surrounding area, and other areas within said appendage, and prior to any attachment of said appendage between a bottle's sidewall 60 and or said bottle's indicia label 62.

FIG. 3,b is a side view showing direction of load stresses, and with said stress directions represented by double end arrows 44, upon said aperture's surrounding area, and other areas within said appendage, and after an attachment of said appendage between a bottle's sidewall 60 and or said bottle's indicia label 62.

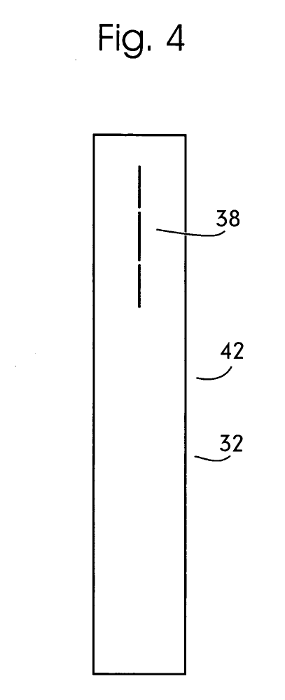

### DETAILED DESCRIPTION OF THE DRAWINGS—FIG. 4 THRU 10,a,b

FIG. 4 is an alternative embodiment of the preferred embodiment with a knock-out aperture 38 which comprises a plurality of gaps between a plurality of said slits.

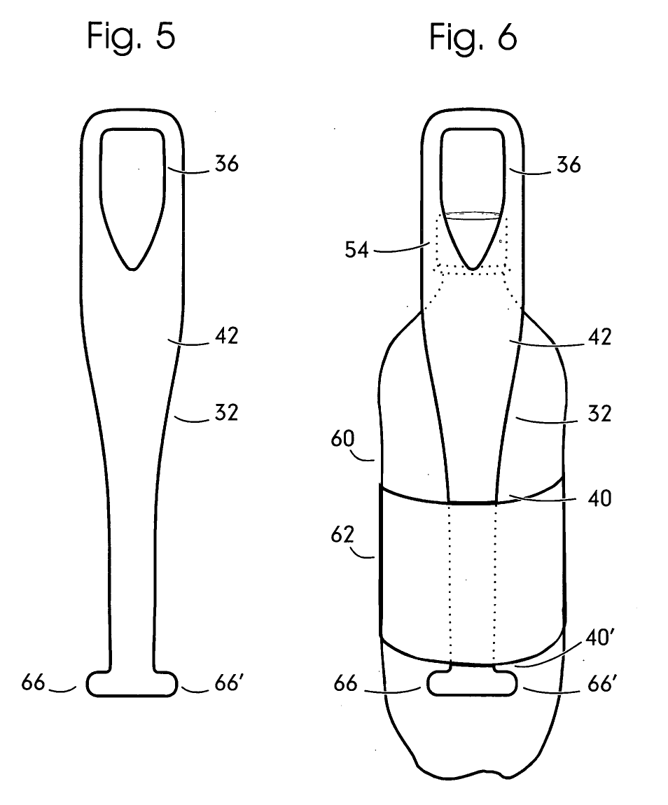

FIG. 5 is a front view of an alternative baseball bat shaped embodiment, and showing a slit formed aperture 36, wherein a plurality of said slits form said aperture with one elongate end of each said slit abutting the next, until an ending point of a final said slit abuts a beginning point of a first said slit. A total of said slits forms an aperture 36 which is approximately square in shape at one elongate end, and tapered in shape at said aperture's opposite elongate end. Said square area's corners and said tapered area's apex are both chamferred to prevent tearing. Said bat's handle area comprises an end knob with tabular projections 66 which serve as a means of attachment between a bottle's sidewall 60 and its attached indicia label 62.

FIG. 6 is a frontal side view of an appended alternative baseball bat shaped embodiment showing two means of attachment; friction and tab projections, and prior to its aperture's application just vertically beneath a bottle's cap stop rim.

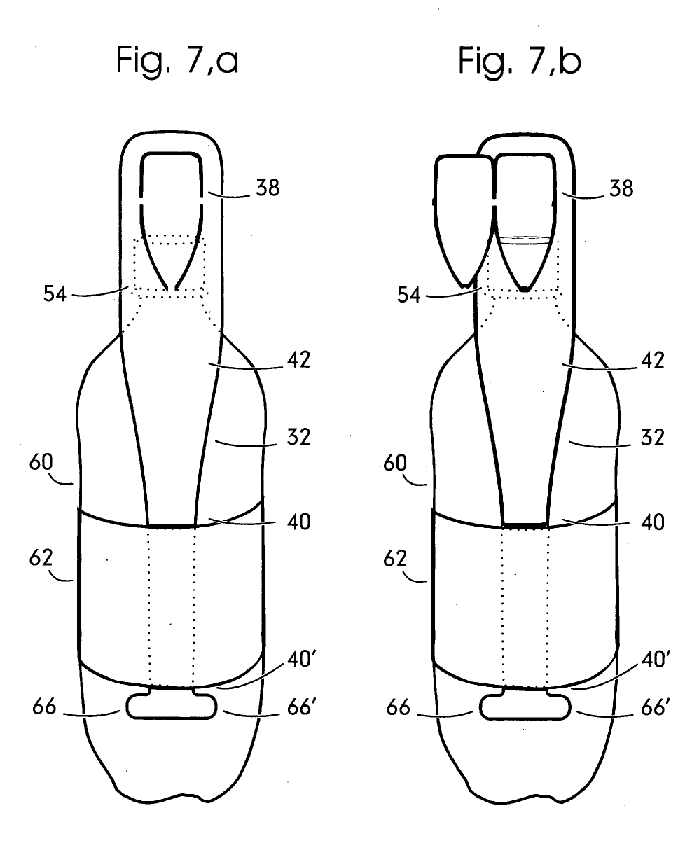

FIG. 7,a,b are frontal side views as in FIG. 6, but showing an aperture's alternative embodiment of an intermittent plurality of abutting through cut slits to form a knock-out aperture 38; and showing before, and as it is being punched out.

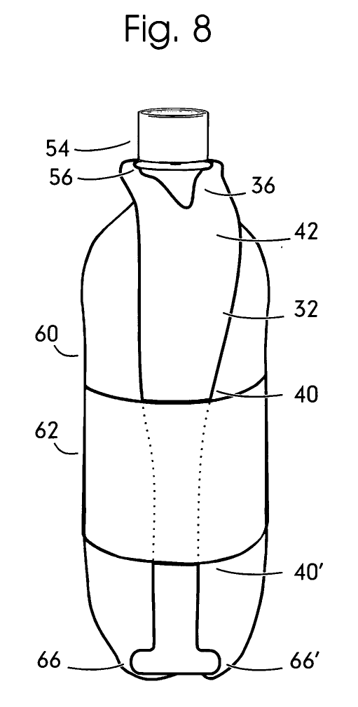

FIG. 8 is a side view of an alternative embodiment positioned for shipping.

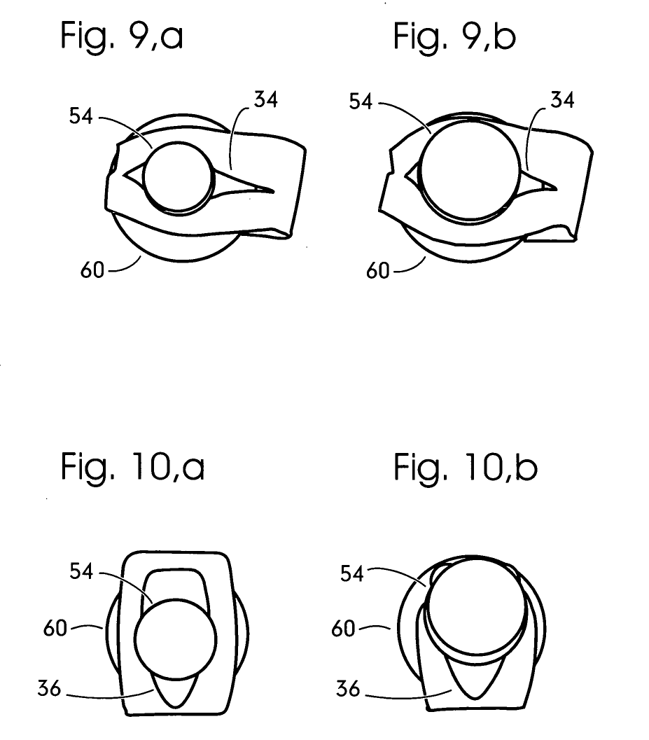

FIG. 9a is an overhead view of the preferred embodiment applied to a standard size small mouth bottle neck with a diameter of approximately 0.924 inches.

FIG. 9,b is an overhead view of the preferred embodiment applied to a standard size large mouth bottle neck with a diameter of approximately 1.45 inches.

FIG. 10,a is an overhead view of an alternative embodiment applied to a standard size small mouth bottle neck with a diameter of approximately 0.924 inches.

FIG. 10,b is an overhead view of an alternative embodiment applied to a standard size large mouth bottle neck with a diameter of approximately 1.45 inches.

### DETAILED DESCRIPTION OF THE DRAWINGS—FIG. 1 THRU 14

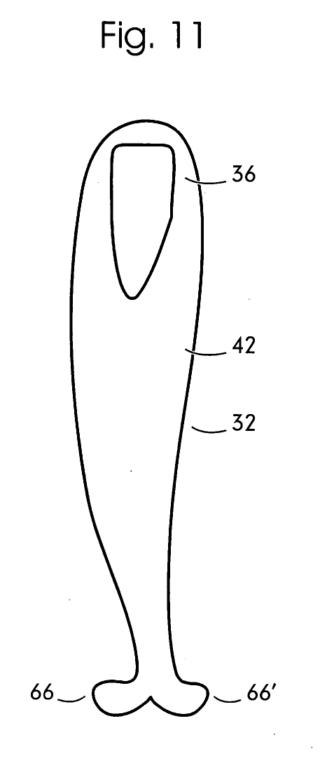

FIG. 11 is a front view of an alternative embodiment with its perimeter edge in a shape of a plurality of water drops, wherein at least one as one or more of said drops serve(s) as a tab projection(s) 66 means for attachment.

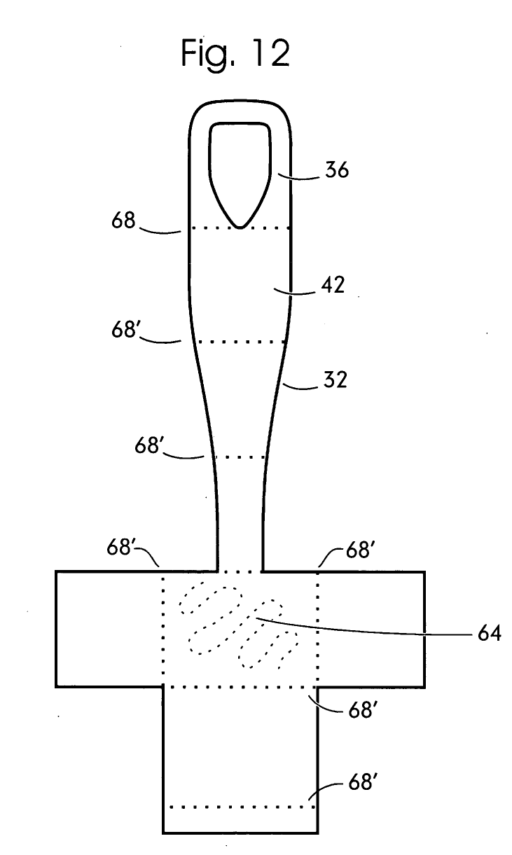

FIG. 12 is a front view of an alternative embodiment of a mylar type plastic film, and wherein portions of its perimeter shape comprise tabular projections for areas to be folded 68 to form a pouch for said embodiment's own containment, and also wherein portions of said embodiment are also folded 68 for its compactment into said containment. Also shown is at least one adhesived 64 planar surface of said pouch which serves as an adhesive means for attachment to said bottle's sidewall 60 and or its attached indicia label 62.

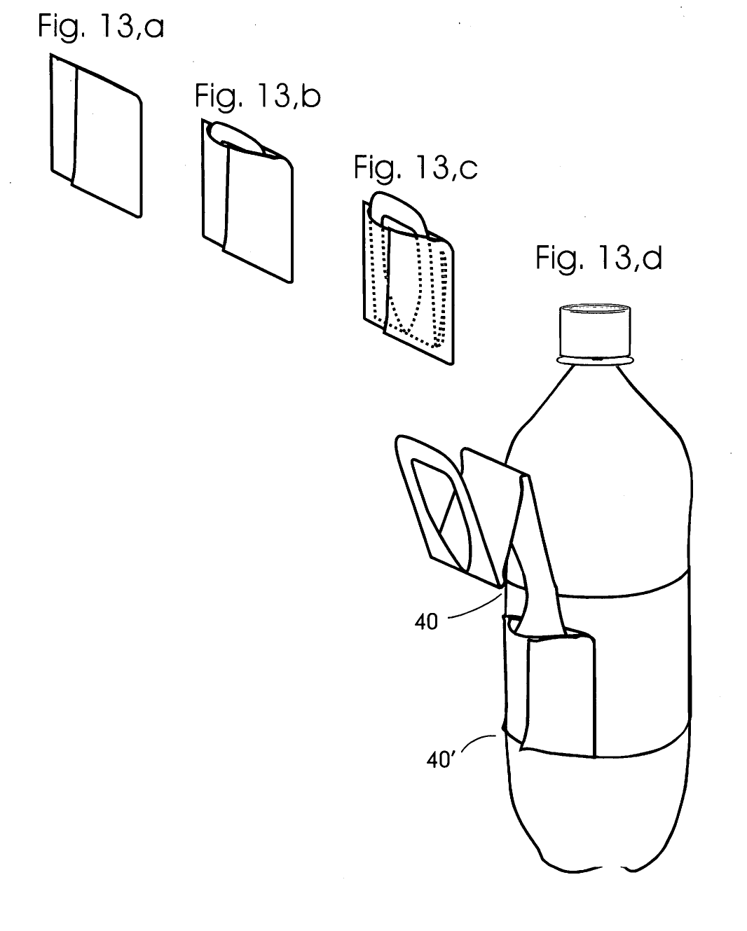

FIG. 13,a,b,c, are side views of alternative embodiments in said pouch form; wherein said appendage is shown in multiple stages of emerging from said pouch, and wherein FIG. 13,d shows said pouch appended to a bottle's indicia label's 62 exterior surface via said adhesive, and with said appendage fully emerged.

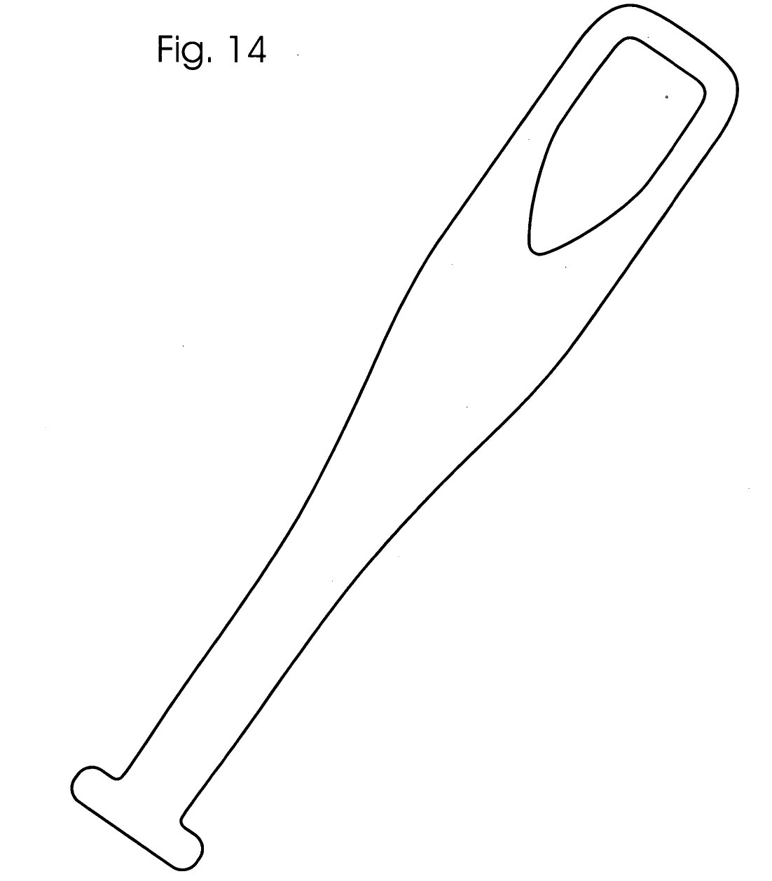

FIG. 14 is a front view of a full scale pattern of said baseball bat shaped alternative embodiment.

### DETAILED DESCRIPTION OF ALTERNATIVE EMBODIMENTS—FIGS. 4, 5

Shown in FIG. 4, is an alternative embodiment with a knock-out aperture.

A manufacturer may choose to form a slightly serrated aperture 38 by using a plurality of said slit(s) with slight gaps between them to form said knock-out shape for a user to physically tear and break open said aperture. Any gaps between said slits in said serrated aperture will be distanced according to a materials thickness and strength to permit a user to easily and completely open said aperture by hand.

Whereas an area surrounding a bottle gripping aperture may come fairly close to a user's mouth, many users prefer to know they are the first to use or come in close contact with said area.

Shown in FIG. 5, is an alternative embodiment with a wider and more exact bottle neck fitting size said elongate aperture.

A manufacturer may use a plurality of said slit(s) to form said aperture 36 with one elongate end of each said slit abutting the next, until an ending point of a final said slit abuts a beginning point of a first said slit. A total of said slits forms an aperture which is approximately square in shape at one elongate end, and tapered in shape at said aperture's opposite elongate end. Said square area and said tapered area's apex are both chamferred to prevent tearing from said aperture's perimeter edge to said appendage's exterior perimeter edge. Said chamferring allows a greater choice of material substrates to use in the manufacturing of said appendage.

Said square area and said tapered area form said elongate aperture wherein its width is approximately that of a diameter of a small mouth bottles neck, and of the area located just beneath said bottle's cap stop rim, and approximately 0.924 inches. An elongate length of said elongate aperture may be anywhere from 1½ or more times its said width; and wherein a manufacturer chooses its final length to accommodate which and how many sizes of large mouth bottle sizes they wish to apply said appendage to.

### DETAILED DESCRIPTION OF ALTERNATIVE EMBODIMENTS—FIGS. 5, 6, 7a, 7b, 8

Also shown in FIG. 5, is said alternative embodiment with an outer perimeter shape of a baseball bat, wherein said bat's handle has an end knob with opposing and laterally projecting tabs 66. In this embodiment, said knobs serve as a means for attaching said appendage to said bottle's attached indicia label 62. Said means of tab projections 66 cooperates with said means of friction to more securely achieve said means of attachment by abutting a vertically lower edge of said indicia label 62. Said tabs 66 remain on a same planar axis as said planar appendage's planar axis, and jut outwardly as said indicia label's curvedly axis follows said bottle's curvature. To quickly see this firsthand, a manufacturing user may copy from the full size pattern as shown in FIG. 14 to form said alternative embodiment from a sidewall of a one gallon plastic milk jug.

Shown in FIG. 6, is said alternative bat shaped embodiment after its appendment to a bottle's sidewall 60 and or its attached indicia label 62, and prior to said appendage's application of its aperture 36 to said bottle's cap 54 or said positioning just beneath a bottle's cap stop rim.

Note the clearance available for said appendage to slide vertically downward for shipping in FIG. 6, and without a need for said application of said aperture.

In FIG. 7,a, said series of abutting slits which form said aperture may have one or more gaps to produce a slightly serrated aperture 38 as in FIG. 4, wherein a user may perform a final knock-out of said aperture. FIG. 7,b shows said aperture as it is partially knocked out and almost ready for a consumer to perform said application of said aperture to said bottle's said cap stop rim positioning.

FIG. 8 shows an appendage in a shipping position wherein said knock-out aperture is not used, and wherein said appendage is appended between said bottle 60 and its attached indicia label 62 and wherein said aperture 36 is in said position located just vertically beneath said cap stop rim 56.

### DETAILED DESCRIPTION OF ALTERNATIVE EMBODIMENTS—figs. 10 A,B, 11, 12

An overhead view is shown in FIG. 10,a,b of said alternative embodiment in a shape of a baseball bat, and as a comparison for an overhead view of FIGS. 9,a and 9,b of a preferred embodiment in same positions. Also shown in FIG. 10,a,b is said elongate aperture containing a square shape at one elongate end which merges with a tapered shape at an opposite elongate end to form said elongate aperture. Said aperture shown in FIG. 10,a is applied to a standard size small mouth bottle neck with a diameter of approximately 0.924 inches. A same said aperture is shown in FIG. 10,b in an overhead view, but applied to a standard size large mouth bottle neck with a diameter of approximately 1.45 inches. Note some distortions in said appendage's area surrounding said aperture, as this particular wide mouth size is an extreme size example.

FIG. 11 shows an alternative embodiment of an appendage with its perimeter shape in a form of a plurality of water drops. At least one or more of said drops serve as said means of tab projections 66. Interiorly located designs and highlights of waterdrop graphics are not shown. Note how said elongate aperture does not have to be exactly symmetrical, yet will still function in its job of more laterally gripping said bottle necks sidewall located just beneath said cap stop rim.

Shown in FIG. 12, is an alternative embodiment wherein a portion of its perimeter edge is shaped to form a pouch for its own containment. In this embodiment, said appendage is made from a very thin mylar type of plastic material, and of a material with rip stop characteristics, and of a material which can be easily folded, and without said folded areas 68 self scoring or ripping. Said material chosen is also glueable to itself, or a bottle's sidewall and or its attached indicia label, and also a said label made of plastic or paper.

When forming said appendage from such a thin plastic material, a cutting of said elongate aperture must be done with precision to prevent any tearing to said appendage's perimeter edge.

### DETAILED DESCRIPTION OF ALTERNATIVE EMBODIMENTS—FIGS. 12, 13,a,b,c,d

When an aperture containing elongate end is completely folded within said pouch, at least one or more of said pouch's pouch forming tabular shapes may be glued to another area of said appendage to form a sealed packet. Said packet may include a glued area 64 on at least one of its two exterior planar surfaces for its attachment to a bottle's sidewall and or its attached indicia label, and at or near a location shown as area 40 in FIG. 13,d.

Said packet may be applied to said bottle's sidewall and or indicia label at a time of manufacturing or by an end user when needed. A user may choose to first apply said aperture over a bottle's cap and just underneath its bottle cap stop rim before adhering said pouch to a bottle's sidewall and or attached indicia label.

FIGS. 13,a,b,c show an unsealed packet in multiple stages of said appendage emerging from its containment pouch. FIG. 13,d shows a packet attached to a bottle's indicia label, and with said appendage completely emerged from said pouch.

### CONCLUSION, RAMIFICATIONS, AND SCOPE

Accordingly, the reader will see that the scope of this new universal fit bottle gripping appendage goes beyond it's many advantages over previous bottle gripping and carrying devices; wherein

This device will not puncture or harm a human user; and wherein its packageability with a product to be held is much more versatile; and wherein its more universal size fitting aperture is also much more versatile.

Although previous descriptions contain many specificities, these should not be construed as limiting the scope of the invention but as merely providing illustrations of some of the presently preferred embodiments of this invention.

What we claim is:

1. A more universal fitting bottle gripping appendage for retaining a bottle to another object, and of a bottle's type wherein an underside edge of said bottle's cap stop rim, and a vertical exterior sidewall of said bottle's neck located just beneath said cap stop rim, and said bottle's exterior sidewall and or attached indicia label are of sufficient strength to cooperatingly bear said bottle's liquid weight stress load, and while said bottle and said appendage are being retained to said another object, comprising;
(i) a thin pliable planar elongate plastic substrate body;
(ii) at least one or more aperture forming through cut slit(s), wherein said aperture is elongate, and elongately parallels said elongate body;
(iii) and a means for said substrate body's attachment to said bottle's exterior sidewall and or said sidewall's attached indicia label;
whereas said another object directs said weight stress load in an area surrounding said aperture in an increased lateral direction;
wherein a portion of said aperture's perimeter edge more firmly abuts said vertical exterior sidewall of said bottle's neck located just beneath said cap stop rim;
wherein a more elongate said aperture functions to grip said underside edge of said bottle's cap stop rim and said vertical exterior sidewall of said bottle's neck located just beneath said cap stop rim;
wherein said more elongate aperture functions to cooperatingly share said weight stress load with said bottle cap stop rim's underside edge and said vertical exterior sidewall of said bottle's neck, and with said another object, and with said bottle's exterior sidewall and or said sidewall's attached indicia label, and with said substrate body, and with said means;
whereby the improvement is a more universal size fitting aperture.

2. The means element of claim 1, wherein said attachment is held by an adhesive;

3. The means element of claim 1, wherein said attachment is held by friction;

4. The means element of claim 1, wherein said attachment is held by at least one or more tab projection(s);

5. The aperture forming through cut slit(s) element of claim 1, wherein a plurality of said slits abut to form said elongate shape aperture;

6. The aperture forming through cut slit(s) element of claim 1, wherein a plurality of said slits abut to form a substantially elongate aperture being approximately square in shape at one elongate end, and approximately tapered in shape at an opposite elongate end;

7. The aperture forming through cut slit(s) element of claim 1, wherein a plurality of said slits abut with a plurality of gaps between said abutments to form a somewhat serrated said elongate aperture, wherein a final knock-out of said aperture is accomplished by a human user.

8. The thin pliable planar elongate plastic substrate body element of claim 1, wherein said substrate is of a polyethylene material.

9. The thin pliable planar elongate plastic substrate body element of claim 1, wherein said substrate is of a polypropylene material.

10. The thin pliable planar elongate plastic substrate body element of claim 1, wherein said substrate is of a polystyrene material.

11. The thin pliable planar elongate plastic substrate body element of claim 1, wherein said substrate is of a polyurethane material.

12. The thin pliable planar elongate plastic substrate body element of claim 1, wherein said substrate is of a plasticized cloth type fabric.

13. The thin pliable planar elongate plastic substrate body element of claim 1, wherein said substrate is of a thin mylar type plastic film.

14. A bottle gripping appendage as in claim 4, wherein an outer perimeter shape of said appendage is substantially that of a baseball bat, and wherein said bat handle's end knob serves as said tab projections.

15. A bottle gripping appendage as in claim 4, wherein an outer perimeter shape of said appendage is of a plurality of overlapping water drops, and wherein at least one or more of said drops serve(s) as said tab projection(s).

16. A bottle gripping appendage as in claim 2, wherein an outer perimeter shape of said appendage is foldable to serve as a pouch for its own containment, and wherein at least one planar surface of said pouch contains an adhesive and serves as said adhesive means of attachment.

17. A bottle gripping appendage as in claim 16, wherein said pouch is adhesively adhered between said bottle's sidewall and said sidewall's attached indicia label.

18. A bottle gripping appendage as in claim 16, wherein said pouch is adhesively adhered to an exterior surface of said bottle's sidewall.

19. A bottle gripping appendage as in claim 16, wherein said pouch is adhesively adhered to an exterior surface of said sidewall's attached indicia label.
